(19) United States
(12) Patent Application Publication
(10) Pub. No.: US 2019/0106840 A1
(43) Pub. Date: Apr. 11, 2019

(54) Multimodal Particles for Retention and Drainage for Paper-Making Machines

(71) Applicant: Applied Material Solutions, Inc., Elkhom, WI (US)

(72) Inventors: Thomas Rebernak, Elkhorn, WI (US); Robert Ellis Wilson, Elkhorn, WI (US); Michael Timothy Jennings, Williams Bay, WI (US)

(73) Assignee: Applied Material Solutions, Inc., Elkhorn, WI (US)

(21) Appl. No.: 16/155,067

(22) Filed: Oct. 9, 2018

Related U.S. Application Data
(60) Provisional application No. 62/570,728, filed on Oct. 11, 2017.

(51) Int. Cl. D21C 9/00; C01B 33/14; D21C 9/18

(52) U.S. Cl. CPC D21C 9/004; C01B 33/14; C01P 2006/12; C01P 2004/64; D21C 9/18

(57) ABSTRACT

A colloidal silica solution which includes two or more colloidal silica compositions or suspensions having differing particle sizes and specific surface areas, the compositions or suspensions resulting in a multimodal particle size distribution in which the solution or suspension can be bimodal in nature and composed of, but not limited to, particles with a mode of 4 nm and 20 nm or composed of particles 7 nm and 12 nm. The solution or suspension can also be trimodal and composed of, but not limited to, 4 nm, 7 nm and 15 nm or 3 nm, 5 nm, and 20 nm. The solution or suspension can also include other multimodal systems which would give superior water drainage and fiber and ash retention on paper machines. The colloidal silica solution is a drainage and retention aid in the making of paper.

### RELATED APPLICATION

This application claims priority to Provisional Patent Application Ser. No. 62/570,728, filed Oct. 11, 2017, the entire contents of which are incorporated herein.

### FIELD OF THE INVENTION

The field is related generally to chemical compounds, and more particularly, to a chemical compound and method for enhanced drainage of water and retention of fine particles in the paper making industry.

### BACKGROUND OF THE INVENTION

Colloidal silica has been used in paper making as a retention and drainage aid in paper making since the 1980's. Colloidal silica is typically run with starch, acrylamide and acrylic polymers, in conjunction with monomodal colloidal silicas. Particle size is normally determined from surface area titrations and is monomodal in nature, centered around 4-5 nm in size.

Drainage aids on paper machines have long been a focus in the paper making industry. The use of chemistries to enhance drainage and retention on paper machines has included cationic starch, polyacrylic acid derivatives, alum and colloidal silica. With the use of colloidal silica there was a noticeable increase in retention and drainage when using the other chemistries previously mentioned. The colloidal silicas used in the past and present are all monomodal in nature.

The manufacturing of colloidal silica for paper machine retention and drainage aids employs the use of a colloidal silica made to a specific particle size, more specifically made to a particular Specific Surface Area (SSA) or particle size which sometimes is calculated from the SSA and other times measured directly by Diffraction Light Scattering (DLS).

As far back as the early 1930's soil particle size of components, or soil packing, has been used to determine hydrolytic flows of water through different types of soil compositions. Soil porosity depends on several factors: (1) packing density; (2) the breadth of the particle size; (3) the shape of the particle; and (4) cementing. The concept of particle packing is currently used in the cement industry; specifically, the use of multi-sized materials in curing and dewatering as well as to increase the strength and stability of cured concrete products.

In the paper making process, it has been historically difficult to improve the retention and drainage on the forming wire. The invention disclosed herein can be applied to the formation of the fiber mat in paper manufacturing and yields improved properties regarding retention and drainage on the forming wire.

In the paper making process an aqueous slurry containing cellulose fiber and various optional fillers and additives, commonly referred to as stock, is fed into a headbox and through the headbox distributed onto a formation wire. In the process the water drains from the sheet through the wire, forming the paper sheet. The sheet is further dewatered in the drying section of the paper machine. In order to increase the drainage of water and retention of the fines (small cellulose fiber) during the formation of the sheet, drainage and retention aids are often used. Typically the drainage aid is also the retention aid.

Silica particles are often used to fill the role of drainage and retention aids on the formation wire. These silica particles are often colloidal dispersions which typically range from 3 nm to 8 nm and are often used in conjunction with anionic or cationic polyacrylate retention aids or cationic starch.

Silicon dioxide (SiO₂) is one of the most common materials on the planet. The advantage of synthesized colloidal silica is controlled surface area and that it is purely amorphous, whereas natural colloidal silica is a mixture of amorphous and crystalline silicon dioxide. One method of manufacturing is the “wet” method where the colloidal silica, or sol, is produced as an aqueous suspension of sub-micron particles of silicate which can be used in this state or converted to gel (silica gel) or powder form (precipitated silica). Silicate soda is treated with sulfuric acid or a high acid ion exchange media to produce intermediate silicic acid. Silicic acid is then converted to colloidal structures in the reaction where size, concentration, porosity, and morphology are formed.

### SUMMARY OF THE INVENTION

The present invention is a colloidal silica solution which is a drainage and retention aid in the making of paper. The application discloses the use of a multimodal colloidal silica which can be used in conjunction with the polymeric retention aid products to improve both retention and drainage properties of paper matrices.

Highly preferred embodiments include a colloidal silica solution comprising two or more colloidal silica compositions or suspensions having (a) differing particle sizes; and (b) specific surface areas, the compositions or suspensions resulting in a multimodal particle size distribution in which the solution is bimodal and composed of, but not limited to, particles with a mode of 4 nm and 20 nm or composed of particles 7 nm and 12 nm; the solution is tri-modal and composed of, but not limited to, 4 nm, 7 nm and 15 nm or 3 nm, 5 nm, and 20 nm; or the solution is comprised of other multimodal systems which have superior water drainage as well as fiber and ash retention on paper machines.

In preferred embodiments, the colloidal silica solution further includes a SiO₂ content of 6% to 50% as well as a mixture of individual colloidal silica solutions or suspensions ranging in particle sizes of between 3 nm to 100 nm. Preferably, the pH of the colloidal silica solution is between 8.0 and 10.5

It is preferred that each of the solutions or suspensions when separate from each other have an individual mean Specific Surface Area of 1,000 m²/g to 30 m²/g and a particle size of 3 nm to 100 nm. Preferably, the solutions or suspensions of colloidal silica when combined together have a mean Specific Surface Area of 999 m²/g to 31 m²/g and a particle size of 3 nm to 100 nm.

Preferred embodiments include the stacking and packing of various colloidal silica solutions or suspensions with varying particle sizes, thereby allowing for increased fiber and ash retention and water drainage due to a resulting formation of channels in a paper sheet which is formed. Preferably the channels allow for faster and more even drainage of water from a fiber mat as well as increased fiber and ash retention in the fiber mat and a more even distribution of fiber and ash across the paper sheet.

Methods of manufacture and use are within the scope of the invention.

### Definitions

“A” or “an” means one or more.
“About” means approximately or nearly, and in the context of a numerical value or range set forth herein, means±10% of the numerical value or range recited or claimed.
“Bimodal” means or refers to having or involving two modes.
“CPAM” means or refers to Cationic Poly-Acrylamide.
“Decant” means or refers to gently pouring a liquid so as not to disturb the sediment.
“EO” means or refers to ethylene oxide or ethoxylated compound.
“FPR” means or refers to First Pass Retention.
“FPAR” means or refers to First Pass Ash Retention.
“Mode” means or refers to the most frequent value of a set of data.
“Molecular weight” means or refers to the average molecular weight of a polymer.
“Multimodal” means or refers to having or involving several modes.
“PAC” means or refers to Poly-Aluminim Chloride.
“PCC” means or refers to Precipitated Calcium Carbonate.
“Silica” means or refers to silicon dioxide.
“Silicate” means or refers to precipitated silica, fumed silica, diatomaceous earth, volcanic ash, talc, and other such compounds which are silicates and are referred to as such throughout the patent.
“Starch” means or refers to a cationic starch used in conjunction with drainage and retention aids.
“Trimodal” means or refers to having or involving three modes.
As used herein, the term “wt. %” means or refers to percent by weight.

### BRIEF DESCRIPTION OF THE DRAWINGS

The application file contains at least one drawing executed in color. Copies of this patent application publication with color drawing(s) will be provided by the Office upon request and payment of the necessary fee.

The drawings illustrate a preferred embodiment including the above-noted characteristics and features of the invention. The invention will be readily understood from the descriptions and drawings. In the drawings:

FIG. 1 is a table illustrating the control sample of the present invention;

FIG. 2 is a table illustrating the composition of the samples tested;

FIG. 3 is a table illustrating the parts per sample including the number of modes and particle size of each part;

FIG. 4 is a table illustrating the drainage and retention evaluations run on each sample;

FIG. 5 is a graph illustrating an example of a mono-modal sol;

FIG. 6 is a graph illustrating an example of a multi-modal sol;

FIG. 7 are tables illustrating the experiment design and sample information;

FIG. 8 are tables illustrating testing results;

FIG. 9 is a graph illustrating testing results;

FIG. 10 is a graph illustrating testing results;

FIG. 11 is a schematic of a dynamic drainage analyzer;

FIG. 12 is a graph illustrating testing results;

FIG. 13 is a graph illustrating testing results; and

FIG. 14 is a graph illustrating testing results.

### DETAILED DESCRIPTION OF THE INVENTION

As seen in FIGS. 1-14 and the disclosure herein, the colloidal silicas relating to this invention are produced by stripping sodium water glass, also known as sodium silicate or silicate soda, using a high acid ion exchange resin. The sodium silicate is converted to a loose version of silicic acid. The silicic acid is run through the reactor under specific conditions (temperature, flow rates, pH and concentrations) to nucleate particles<5 nm.

Once seeds are formed, silicic acid is fed at varying rates to push the reaction toward accretion as opposed to nucleation (typically by controlling temperature and flow rate/concentration). The particle is grown to the desired size needed.

The raw product is then allowed to ripen (using Ostwald ripening effects) for a brief period of time. The concentration is typically 6-8% solids by weight. Once ripened and at an appropriate temperature, raw colloidal silica is run through ultra-filtration to de-water the product. Therefore colloidal silica at 6-8% solids can be concentrated up to 50%.

Final concentration is limited by particle size, time, and economics. Smaller particles become more unstable as concentration rises. As concentration passes the threshold limitations it begins to agglomerate. During this period there is a high risk of gel formation. The water removal process involved is not a linear process but is asymptotical. Once the final concentration is achieved the material is transferred to a finishing tank. The multi-modal systems for this invention are built by blending discrete mono-modal standard products to build the desired specific surface area and particle size distribution.

In the present application, a colloidal silica based (SiO2) system comprised of two or more particle sizes provides better drainage and fines retention on the formation table of the paper machine. The manufacturing of colloidal silica for paper machine retention and drainage aid employs the use of a colloidal silica made to a specific particle size. More specifically, it is made to a stated particular SSA (Specific Surface Area) or particle size, sometimes calculated from the SSA or alternatively calculated by measuring DLS (Diffraction Light Scattering). In the present application, the use of a multimodal colloidal silica system which can be used in conjunction with the polymeric retention aid products, such as polyacrylamide or cationic starch, is used to improve both retention and drainage properties of the paper matrices.

Typically, soil particle size of components or soil packing is used to determine hydrolytic flows of water through different types of soil compositions. Soil porosity depends on several factors: (1) packing density; (2) the breadth of the particle size; (3) the shape of the particle; and (4) and cementing. The concept of particle packing is currently used in the cement industry; for example, the use of multi-sized materials in curing and dewatering areas as well as to increase the strength and stability of cured concrete products. This concept can also be applied to the formation of the fiber mat in paper manufacturing and results in improved properties regarding retention and drainage on the forming wire.

The present application discloses that a multi-modal colloidal silica dispersion would allow for better particle packing of the colloidal silica, thereby improving the drainage, paper fines retention and sheet formation over the single modal system that is currently in use today. A multi-modal colloidal silica dispersion would allow for the formation of channels in the sheet. This would cause faster drainage of water through the sheet and a more even dispersion. It would also result in better fiber retention for the sheet as it is formed on the wire, resulting in better overall sheet formation.

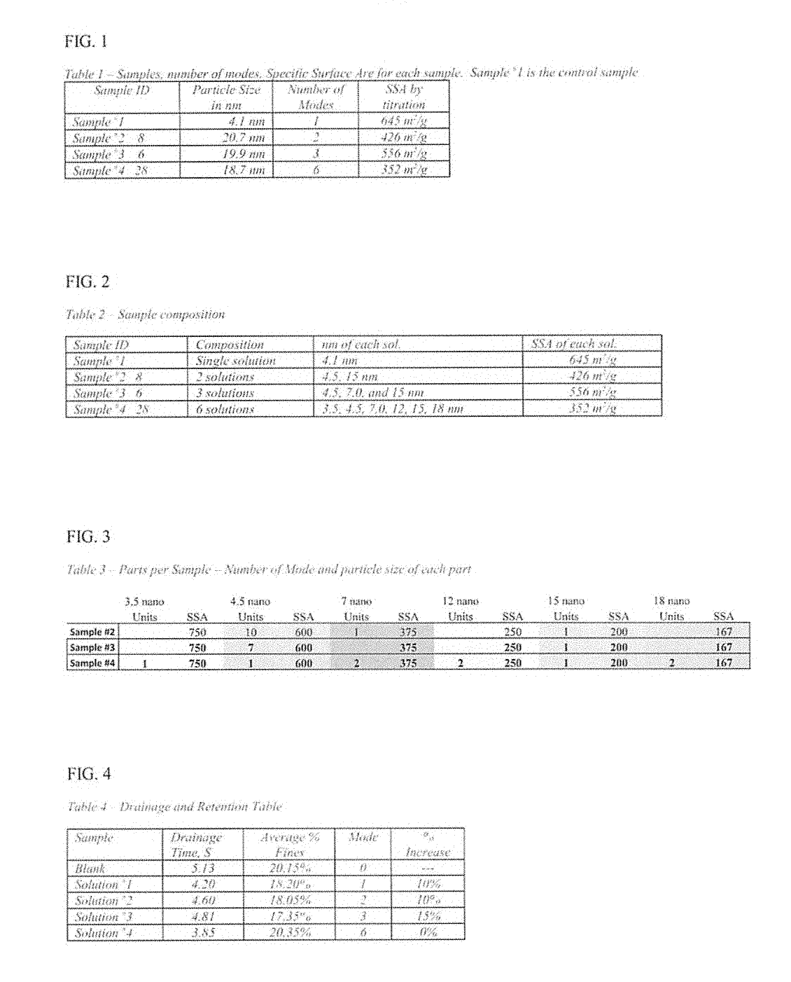

In the present application four samples were prepared. Particle size was measured using Diffraction Light Scattering. The sample measurements can be seen in FIGS. 1-4. FIG. 1 illustrates Table 1 which was the control sample. FIG. 2 or Table 2 illustrates the composition of samples tested. FIG. 3 or Table 3 illustrates the parts per sample including the number of modes and particle size of each part. FIG. 4 or Table 4 illustrates the drainage and retention evaluations run on each sample.

The results in FIGS. 1-4 illustrate that the drainage was faster on all samples over the Blank FIGS. 1-4 also illustrate that the drainage appeared to get slower as the number of different particle sizes were increased. This result could be a function of average particle size and SSA as it is the number of modes. The retention of fines increased as the modality of the samples increased until there were six different modes in sample #4.

With the decrease in drainage time and the lack of fiber retention it is evident that the number of modes and the quantity of larger particles will play a large role in how well the final product works.

FIGS. 1-4 illustrate that the channeling may be significantly better with six modes. It is possible though that the channels may be too large and allow fines to flow through the mat, the cause of which may be due to the size and the quantity of the larger particles added to sample #4. The optimum size of the channels is important and must be controlled. The channels need to be large enough and there must be a sufficient number of channels to allow for good drainage of the water, yet the channels must not be so large that the fines can pass through.

FIGS. 1-4 disclose a colloidal silica solution having two or more colloidal silica compositions or suspensions with differing particle sizes and specific surface areas. The compositions or suspensions result in a multimodal particle size distribution in which the solution is bimodal and composed of, but not limited to, particles with a mode of 4 nm and 20 nm or composed of particles 7 nm and 12 nm; the solution being tri-modal and composed of, but not limited to, 4 nm, 7 nm and 15 nm or 3 nm, 5 nm, and 20 nm; or the solution comprised of other multimodal systems which have superior water drainage as well as fiber and ash retention on paper machines. The colloidal silica solution is a drainage and retention aid in the making of paper.

The colloidal silica solution includes a SiO₂ content of 6% to 50% as well as a mixture of individual colloidal silica solutions or suspensions ranging in particle sizes of between 3 nm to 100 nm. The pH of the colloidal silica solution is between 8.0 and 10.5.

The solutions or suspensions when separate have an individual mean Specific Surface Area of 1,000 m²/g to 30 m²/g and a particle size of 3 nm to 100 nm. The solutions or suspensions of colloidal silica when combined together have a mean Specific Surface Area of 999 m²/g to 31 m²/g and a particle size of 3 nm to 100 nm.

FIGS. 1-4 illustrate that stacking and packing of various colloidal silica solutions or suspensions with varying particle sizes allows for increased fiber and ash retention and water drainage due to a resulting formation of channels in a paper sheet which is formed. The channels allow for faster and more even drainage of water from the fiber mat as well as increased fiber and ash retention in the fiber mat and a more even distribution of fiber and ash across the paper sheet.

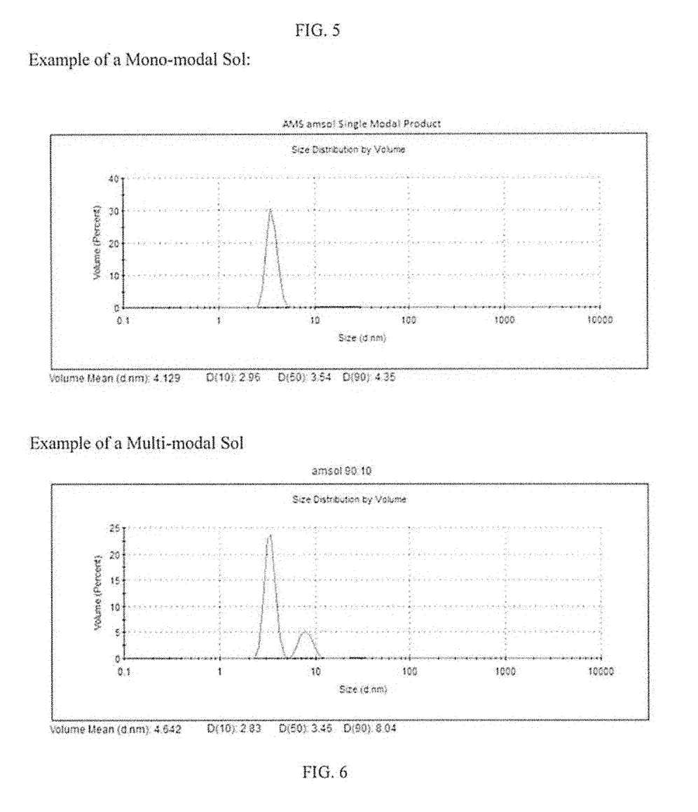

FIG. 5 illustrates an example of a mono-modal sol whereas FIG. 6 illustrates an example of a multi-modal sol. The differences between a mono versus a multi-modal sol can be seen in FIGS. 5 and 6.

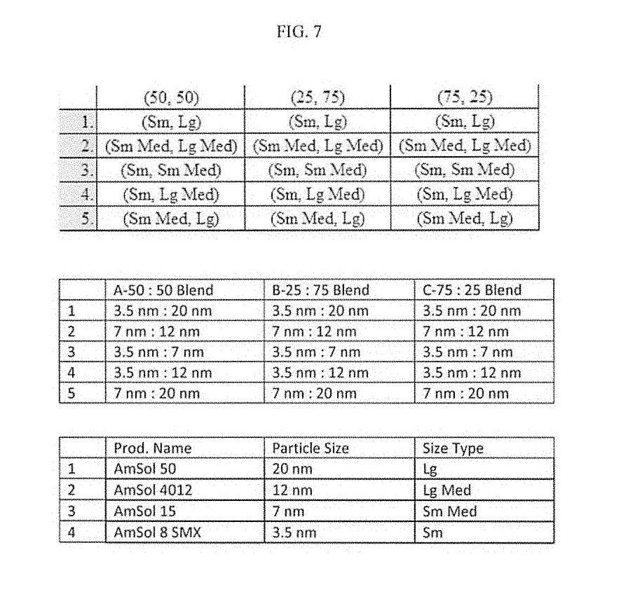

FIG. 7 consists of three charts. The first chart (top of FIG. 7) illustrates how the experiment was designed. The second and third charts (middle and bottom charts on FIG. 7) illustrate how the experiment samples were prepared. Each sample was labeled with the product name which is commercially available from the applicant (this includes AmSol 50, Amsol 4012, AmSol 15 and AmSol 8 SMX) or alternatively labeled with the control name with lot number. Blended samples which were used in the experiment have lot numbers based on the date of manufacture. Samples which were sent out for testing are labeled A1, A2, A3, A4 and A5 and the same labeling format was also used for B and C samples.

The relevant experiments in the present application were performed using a Britt Jar Test and the testing was performed in the following manner. Three pulp fiber samples were used as a stock slurry in the test: bleached ground wood pulp, bleached soft wood kraft pulp and bleached hardwood kraft pulp. The pulp samples were each tested for fiber content. The solid content for the bleached hardwood kraft was 3.21% and for both the bleached softwood kraft and ground wood it was 3.45%.

The stock fiber suspension for the testing was prepared by mixing 60% hardwood kraft, 20% softwood kraft and 20% ground wood. The stock fiber suspension was added with a desired amount of Precipitate Calcium Carbonate (“PCC”) so that the final stock slurry contained 25% PCC (as received) and 75% stock fiber suspension.

The stock slurry was added with 15 lb/ton of newly prepared starch solution (dry starch/dry ton of fibers) under stirring. This was followed by the addition of PAC in the amount of 4 lb/ton of fibers. The mixture was diluted to contain 0.7% fibers. 70 g diluted slurry aliquot (accurate to 0.1 g) was weighed into a beaker. After the Britt Jar was set up, the slurry was poured into the jar. 430 g water was used to rinse all the content into the jar. The final fiber suspension in the jar was 500 g. When stirring at 1000 rpm had run for 10 seconds, CPAM in the amount of 1 lb per ton of fibers was added; after another 10 seconds a desired amount of diluted silica sample was added, and after another 10 seconds had passed the drainage of the jar was open.

Around 80 to 100 g filtrate was collected within a period of 30 seconds. The filtrate was filtered through a weighted Whatman ashless filter paper. The dry weight of the fines was determined after overnight drying in a 105° C. oven. The fines were then ashed under 525° C. for five hours.

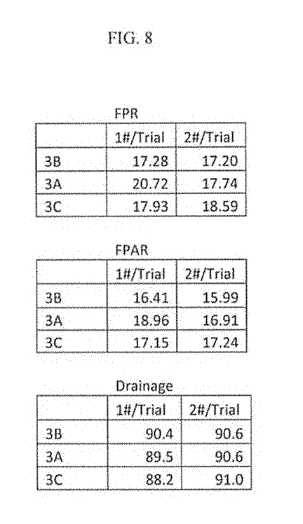

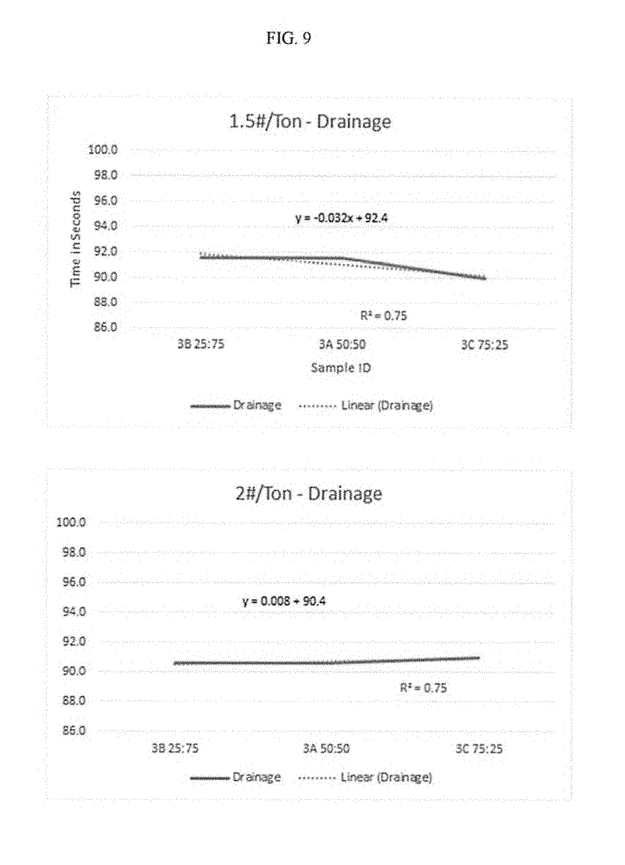

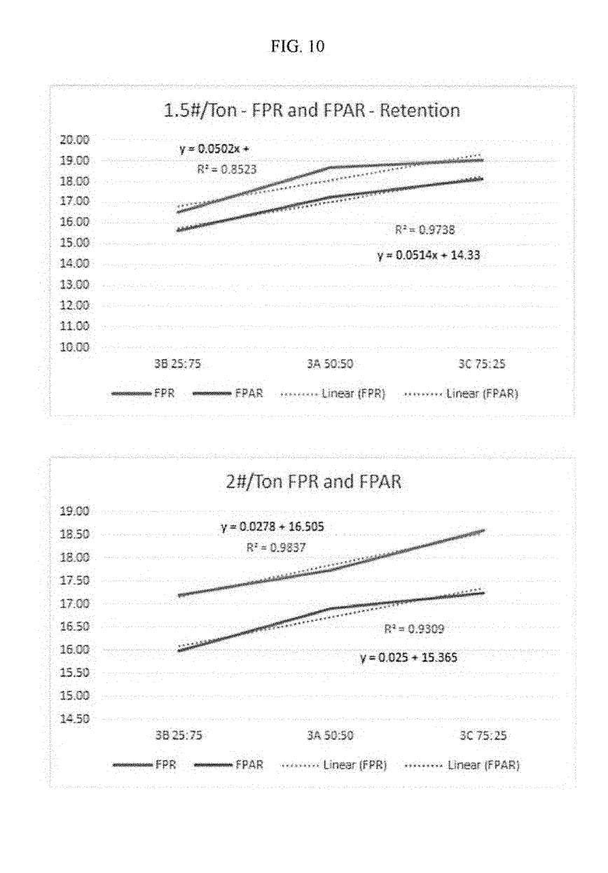

The results showed various effects on Retention and Drainage, but the results of Sample 3A, 3B, and 3C were very linear and indicated strongly that the particle ration to optimize Drainage and Retention could be predicted. The Results for 3A, 3B, and 3C are seen in FIG. 8. FIGS. 9-10 were also generated based on the results of the above-noted experiment.

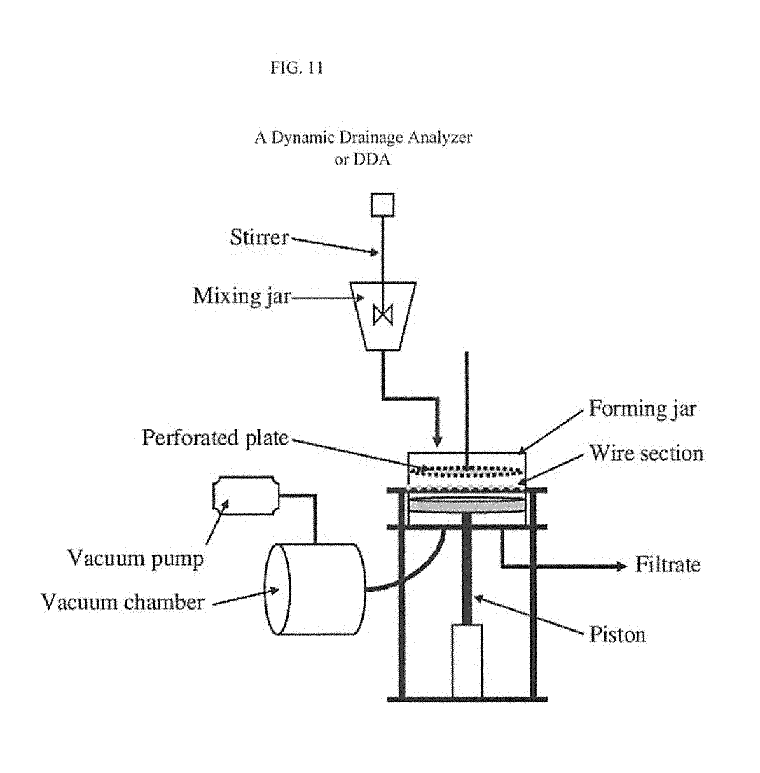

Additional experiments were done using a Dynamic Drainage Analyzer (see FIG. 11) to measure the rate of water flow through a screen. A vacuum was applied to the chamber receiving the water. The water was allowed to flow into the chamber and data points were collected at a rate of 1 data point per second to 5 data points per second depending on the model. The amount of time it took to drain a given amount of water was measured in seconds. A schematic of a Dynamic Drainage Analyzer is shown in FIG. 11.

The following testing protocol was used to make the pulp slurry for the testing in the Dynamic Drainage Analyzer: 60% of hardwood (short fiber); 20% softwood (long fiber) and 20% ground wood or Thermomechanical Pulping. 25% of PCC filler was also added. The thick stock additives consisted of starch at 15 lb/ton and PAC at 4 lb/ton. The thin stock consistency was 0.70% and thin stock additives consisted of CPAM and silica (dry solids 2.0 lb/ton).

The timing sequence used for the vacuum drainage on the Dynamic Drainage Analyzer is below.

Sequence: 1000 rpm, 30 sec.
T=0 sec: Start Sequence
T=10 sec: Add CPAM
T=20 sec: Add Silica
T=30 sec: Start register pressure vs time

The timing sequence used for the dynamic drainage jar (Britt Jar) for First Pass and Ash Retention is below.

Sequence: 1000 rpm, 30 sec.
T=0 sec: Start Sequence
T=10 sec: Add CPAM
T=20 sec: Add Silica
T=30 sec: Recovery of Filtrate through “Syracuse 125 P” Screen (White Waters)

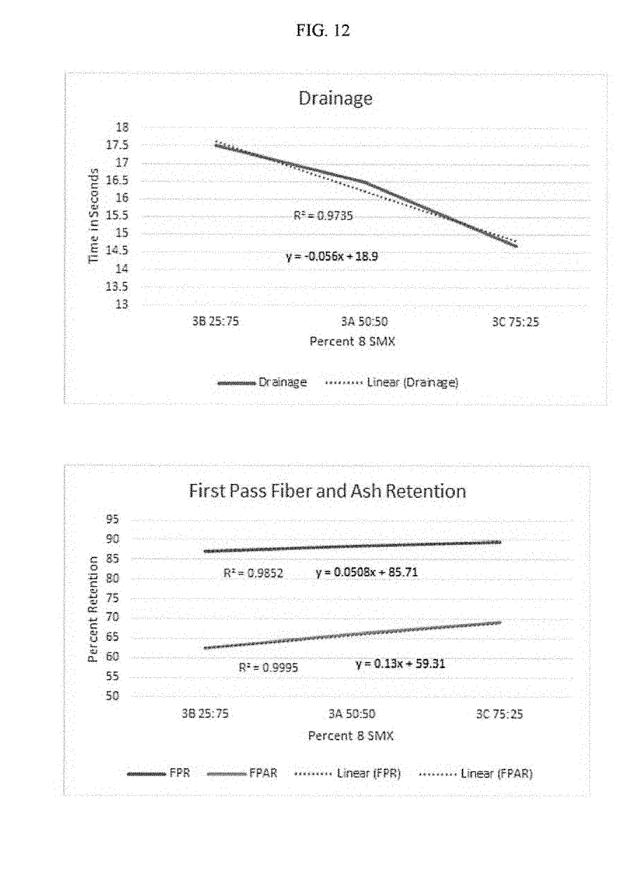

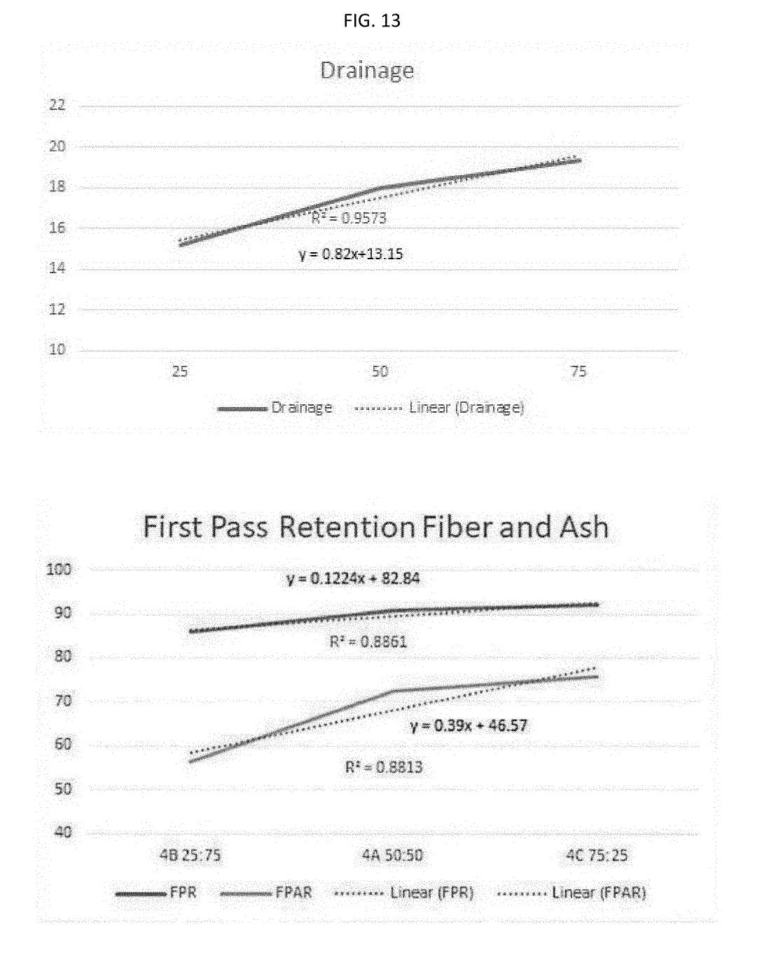

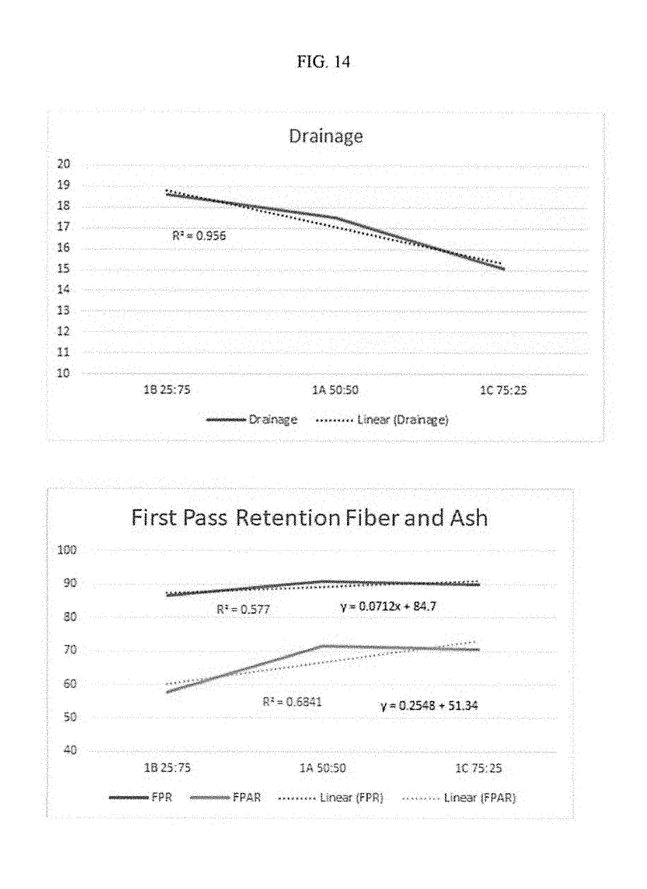

The pulp capture was weighed out for the percent retention then ashed for the first pass retention in a similar manner as was done with the Britt Jar testing. The results can be seen in the graphs in FIGS. 12-14. FIG. 13 illustrates the results of samples 1A, 1B and 1C. FIG. 14 illustrates that 1A through 1C show that the linear correlation decreases with some silica mixtures.

Overall, FIGS. 12-14 show that mixing particles of different sizes will impact the drainage, the First Pass Retention and the First Pass Ash Retention. Once a line is calculated it becomes possible to then calculate the proper mixture of particles necessary to have the desired drainage and retention as noted and claimed in this application.

Wide varieties of materials are available for the various parts discussed and illustrated herein. While the principles of this invention and related method have been described in connection with specific embodiments, it should be understood clearly that these descriptions are made only by way of example and are not intended to limit the scope of the application. It is believed that the invention has been described in such detail as to enable those skilled in the art to understand the same and it will be appreciated that variations may be made without departing from the spirit and scope of the invention.

1. A colloidal silica solution comprising two or more colloidal silica compositions or suspensions having: (a) differing particle sizes; and (b) specific surface areas, the compositions or suspensions resulting in a multimodal particle size distribution wherein:
the solution being bimodal and composed of, but not limited to particles with a mode of 4 nm and 20 nm or composed of particles 7 nm and 12 nm;
the solution being tri-modal and composed of, but not limited to, 4 nm, 7 nm and 15 nm or 3 nm, 5 nm, and 20 nm; or
the solution comprised of other multimodal systems which have superior water drainage as well as fiber and ash retention on paper machines,
whereby the colloidal silica solution is a drainage and retention aid in the making of paper.

2. The colloidal silica solution of claim 1 further including a SiO₂ content of 6% to 50%.

3. The colloidal silica solution of claim 1 further including a mixture of individual colloidal silica solutions or suspensions ranging in particle sizes of between 3 nm to 100 nm.

4. The colloidal silica solution of claim 1 wherein the pH of the colloidal silica solution is between 8.0 and 10.5.

5. The colloidal silica solution of claim 1 wherein each of the solutions or suspensions when separate have an individual mean Specific Surface Area of 1,000 m²/g to 30 m²/g and a particle size of 3 nm to 100 nm.

6. The colloidal silica solution of claim 1 wherein the solutions or suspensions of colloidal silica when combined together have a mean Specific Surface Area of 999 m²/g to 31 m²/g and a particle size of 3 nm to 100 nm.

7. The colloidal silica solution of claim 1 wherein stacking and packing of various colloidal silica solutions or suspensions with varying particle sizes allows for increased fiber and ash retention and water drainage due to a resulting formation of channels in a paper sheet which is formed.

8. The colloidal silica solution of claim 7 wherein the channels allow for faster and more even drainage of water from a fiber mat as well as increased fiber and ash retention in the fiber mat and a more even distribution of fiber and ash across the paper sheet.
